(19) United States
(12) Patent Application Publication
(10) Pub. No.: US 2013/0154448 A1
(43) Pub. Date: Jun. 20, 2013

(54) ELECTRICAL MACHINE FOR A MOTOR VEHICLE

(71) Applicant: Matthias Schick, Ludwigsburg (DE)

(72) Inventor: Matthias Schick, Ludwigsburg (DE)

(21) Appl. No.: 13/714,080

(22) Filed: Dec. 13, 2012

(30) Foreign Application Priority Data
Dec. 14, 2011 (DE) 10 2011 088 500.5

(51) Int. Cl. H02K 11/00; H02K 13/00

(52) U.S. Cl. CPC H02K 11/001; H02K 13/00
USPC 310/68 B

(57) ABSTRACT

An electrical machine, e.g., a starter motor for a motor vehicle, includes at least one carbon brush for producing an electrical sliding contact with a commutator, and a displacement sensor for detecting wear of the carbon brush.

### BACKGROUND OF THE INVENTION

1. Field of the Invention

The present invention relates to an electrical machine, e.g., a starter motor, for a motor vehicle, having at least one carbon brush for producing an electrical sliding contact.

2. Description of the Related Art

For the most part, mechanically commutated DC motors are used to start combustion engines in motor vehicles. The current supplied is fed across one or more pairs of brushes via the commutator into the armature winding. These brushes are usually made of a sintered material having portions of copper and graphite. During operation, the carbon brushes and the commutator are subject to wear.

Starter motors are typically designed for short-duration operation, and are suitable for 30,000-60,000 switching cycles. If the starter motor is to be designed for higher loads or for longer operating times (for example, as necessary in the case of start/stop operation), it turns out that the use of as many pairs of carbon brushes as possible can lead to the maximum possible service life. In this context, for example, in the case of starter motors for start/stop operation, six instead of four carbon brushes are used for a 6-pole electrical machine. Meanwhile, for start/stop areas of application, the number of switching operations required may amount to more than 250,000 cycles.

### BRIEF SUMMARY OF THE INVENTION

An object of the present invention is to provide an electrical machine for which technical maintenance is able to be improved and simplified.

According to one aspect of the present invention, this objective is achieved by an electrical machine for a motor vehicle, particularly a starter motor, having at least one carbon brush for producing an electrical sliding contact with a commutator, and having a displacement sensor for detecting wear of the carbon brush. In this manner, the advantage is achieved that the wear and the operativeness of the electrical machine may be determined without the need for the electrical machine to undergo a manual inspection. In addition, the safety of a motor vehicle against failure is improved by the electrical machine of the present invention, since it is possible to determine when the wear of the carbon brushes lies above a critical mark. In this case, it is possible to find a garage in timely fashion, so that an inadvertent breakdown of the vehicle may be avoided.

In one advantageous specific embodiment, the displacement sensor is provided to detect a displacement of the carbon brush. In this manner, for example, the technical advantage is achieved that a displacement may be measured especially precisely with only minor technical expenditure, and the design of the electrical machine is simplified.

In a further advantageous specific embodiment, the displacement sensor includes a measuring pin which is in contact with the carbon brush. In this manner, for example, the technical advantage is achieved that the position of the carbon brush transfers mechanically to a different location, at which it may then be measured.

In a further advantageous specific embodiment, the measuring pin is produced from a carbon-fiber-reinforced plastic. In this manner, for example, the technical advantage is achieved that the measuring pin is particularly insensitive to thermal stresses.

In another advantageous specific embodiment, the measuring pin includes a metallic cladding. In this manner, for example, the technical advantage is achieved that the position of the measuring pin may be obtained by electrical means via a coupling of the metallic cladding.

In a further advantageous specific embodiment, the displacement sensor includes a primary coil and at least one first secondary coil. In this manner, for example, using simple technical means, the technical advantage is achieved that an electronic displacement sensor is formed for detecting the position of the metallic cladding.

In another advantageous specific embodiment, the displacement sensor includes an oscillator for converting a DC voltage into an AC voltage. In this manner, for example, the technical advantage is achieved that a DC voltage of the vehicle electrical system may be used to operate the displacement sensor.

In another advantageous specific embodiment, the oscillator is connected electrically to the primary coil. In this manner, for example, the technical advantage is achieved that an alternating current is fed into the primary coil for detecting the position of the measuring pin, and the accuracy of the measurement is increased.

In a further advantageous specific embodiment, the displacement sensor includes a demodulator for filtering an output voltage. In this manner, for example, the technical advantage is achieved that interference effects or noise in a signal line are suppressed.

In another advantageous specific embodiment, the displacement sensor includes a second secondary coil. In this manner, for example, the technical advantage is achieved that the voltages induced in the two secondary coils are able to be demodulated, filtered and connected back-to-back. In this context, the position of the pin is selected in such a way that an output voltage of 0V results in the starting position.

In another advantageous specific embodiment, the demodulator is connected electrically to the first and the second secondary coil. In this manner, for example, the technical advantage is achieved that voltage noise induced in the coils is able to be eliminated.

In a further advantageous specific embodiment, the demodulator includes a comparator for comparing the voltages induced in the first and the second secondary coil. In this manner, for example, the technical advantage is achieved that the position may be determined precisely in relation to a reference point situated between the coils.

In another advantageous specific embodiment, the electrical machine has a motor housing having a feed-through opening for leading the measuring pin through. In this manner, for example, the technical advantage is achieved that the position of the carbon brush is able to be measured from outside of the housing.

In another advantageous specific embodiment, the motor housing has at least one tapped hole for securing the displacement sensor. In this manner, for example, the technical advantage is achieved that the displacement sensor may be secured to the housing by a screw connection.

In another advantageous specific embodiment, the motor housing has a depression for accommodating the displacement sensor. In this manner, for example, the technical advantage is achieved that the displacement sensor has good contact with the housing.

In a further advantageous specific embodiment, the electrical machine has a motor housing having a feed-through opening for leading the measuring pin through, the feed-through opening being located directly over one or more carbon brushes. In this manner, for example, the technical advantage is achieved that the motor is disposed in protected fashion in the interior of the housing, and the wear of the carbon brushes may be measured from the outside of the housing.

### BRIEF DESCRIPTION OF THE DRAWINGS

FIG. 1 shows a cross-sectional view of an electrical machine having a displacement sensor for detecting carbon-brush wear.

FIG. 2 shows a schematic view of the displacement sensor.

FIG. 3 shows a top view of one specific embodiment of a motor housing.

FIG. 4 shows a top view of a further specific embodiment of a motor housing.

FIG. 5 shows a schematic view of the electrical machine.

FIG. 6 shows a schematic cross-sectional view of the electrical machine having the displacement sensor.

### DETAILED DESCRIPTION OF THE INVENTION

Typically, electrical machines which are used as start/stop starter motors are operated with an “8/1 cycle sequence” for release in the motor endurance test run. That is to say, the electrical machines are triggered with 8× short start (start/stop operation) and with 1× long start. In the case of a short start, the trigger times lie between 0.2 s and 0.5 s. The long start lies in the area of 1 s. In addition, there are overrun phases which are different depending on the starting performance of the motor, and during which the ring gear of the combustion engine overruns the starter pinion, and the ring gear rotates faster than the starter pinion. This cycle sequence of long and short starts also occurs in the case of a series vehicle, for example, when cold or warm starts are carried out with a vehicle. The temperature of the combustion engine, atmospheric humidity, strong oscillations or vibrations at the motor and other contamination or impurities, for example, represent further stresses.

The influence variables cited above lead to a linear wear behavior of the carbon brushes in the electrical machine. At present, it is customary during test operation to measure the carbon-brush wear manually with the aid of a sliding caliper and an additional mechanical auxiliary device. In order to be able to determine the carbon-brush wear and enter it into a wear diagram (X-axis=number of switching operations/Y-axis carbon-brush wear), the endurance-test motors must be stopped and undergo a one to two-hour cool-off phase, since start/stop motor endurance tests are undertaken with temperatures between 60° C. and 90° C. Depending on the installed position of the starter, in many cases, the starter must be removed completely from the motor, in order to permit the carbon-brush wear to be measured at all. This means that, due to downtimes, numbers of switching operations get lost during time-critical release tests, and in addition, manpower is needed for such an activity/measurement.

Costs are incurred for the employees conducting the tests and for the downtimes in the internal motor test facility. This procedure, that is, demounting of the starter and manual measurement of the carbon-brush wear, is also necessary in the case of series use on the vehicle if one would like to determine information about the carbon-brush wear of a mass-production electrical machine at “X” number of switching operations. To that end, as a rule, the vehicle must be ordered to go into a suitable specialized garage in which the electrical machine is then demounted from the vehicle, since measurement of the carbon-brush wear is only possible after demounting. However, for this, the specialized garages would have to disassemble the starters, since the necessary measuring bores are not present on a series starter and additional measuring equipment is necessary.

The present invention describes an automated measuring principle for determining the wear of carbon brushes, in which no downtimes occur, for example, due to mounting and demounting of the starter for measuring the carbon-brush wear. Moreover, the carbon-brush wear values may always be represented and read off accurately according to number of switching operations in a program which processes the signals of the measuring devices. Measuring errors are able to be minimized by an automatic measurement of the wear value.

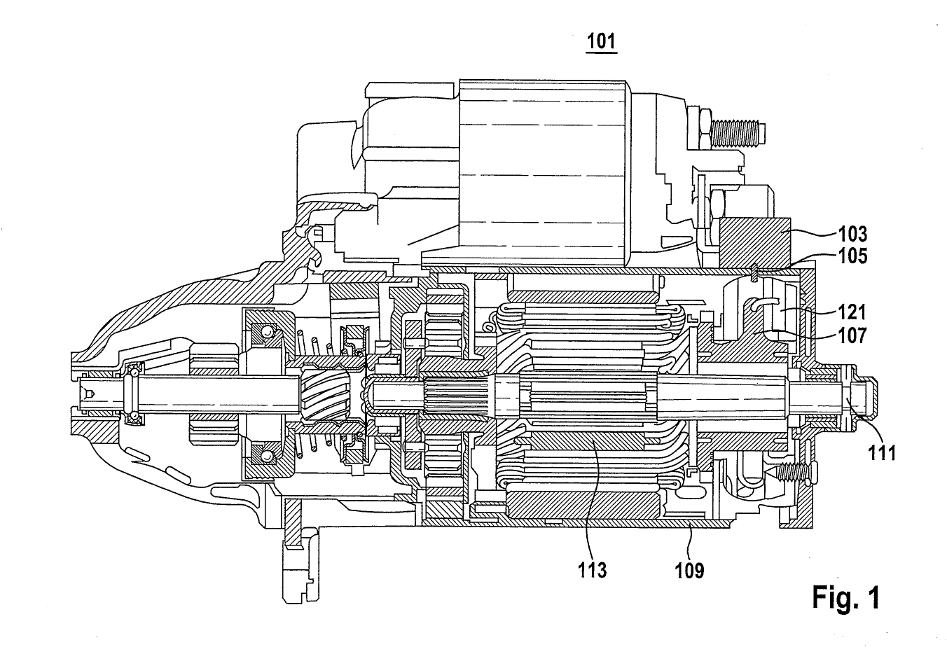

FIG. 1 shows a cross-sectional view of an electrical machine 101. Electrical machine 101 is used as a starter motor for driving a combustion engine in a vehicle when starting the combustion engine.

Electrical machine 101 includes a motor housing 109, on which a displacement sensor 103 having a measuring pin 105 is disposed. Situated in motor housing 109 is a rotation axis 111, on which rotor winding 113 is located. Rotor winding 113 is led outwards on the commutator via slip rings and carbon brushes 107.

Carbon brush 107, also called brush, contact brush or motor carbon, is a sliding contact in electrical machine 101 and produces the electrical contact to the lamina of the rotating part—called commutator or perhaps collector—of the electrical machine, e.g., a rotor or armature. Carbon brushes are usually made of graphite. However, depending on the application case, carbon brushes may also either be enriched with metallic components such as copper, silver or molybdenum, or may be made entirely of metal.

Carbon brush 107 is disposed displaceably in the housing in a carbon-brush box 121 which is pushed by a pressure spring in the direction of the electrical contact point. The material of carbon brush 107 is worn away by the friction taking place between the rotor and carbon brush 107. In this case, carbon brush 107 is followed up by the pressure spring, so that an electrical contact with the rotor is able to be ensured. In the case of electrical machines used as starter motors, the wear to be measured on a carbon brush 107 typically lies in the range of 0 mm to 13.0 mm.

Displacement sensor 103 is provided to determine the wear of the carbon brushes. For example, this may be accomplished by determining the displacement of carbon brush 107 on the basis of the wear in the interior of housing 109. A displacement sensor may be used for this purpose, for instance, which measures the distance covered by carbon brush 107 during an operation of electrical machine 101.

For example, such a displacement sensor may be formed by a direct current/direct current displacement sensor, also called DC/DC displacement sensor. The DC/DC displacement sensor is fed a DC voltage as input voltage, which is converted into an output DC voltage whose magnitude corresponds to a measured displacement. In this context, the DC/DC displacement sensor is constructed in such a way that it may be utilized for adaptation for production applications on the vehicle.

The advantage of a displacement sensor is that the wear values of carbon brushes 107 may be co-stored directly via evaluation electronics, which are already available in most vehicles, e.g., in a control unit or fault memory.

Since a fault memory in the vehicle is read out as standard practice during each general inspection in a specialized garage, the wear values could thus be read out from the memory, and in the second step, arrive online at the vehicle manufacturer or motor manufacturer. In addition, the wear values may be coupled to a start counter which records the number of motor starts. In this manner, at each wear-measuring point, an assignment to the number of starts may be made.

The manufacturer is thus able to obtain valuable information about the start/stop systems in serial production. It would also be conceivable that not every vehicle of a model series is equipped with such a measuring system, so that only a limited number of vehicles receive this additional system, and a statistical statement may be made about the wear measurement “in the field.”

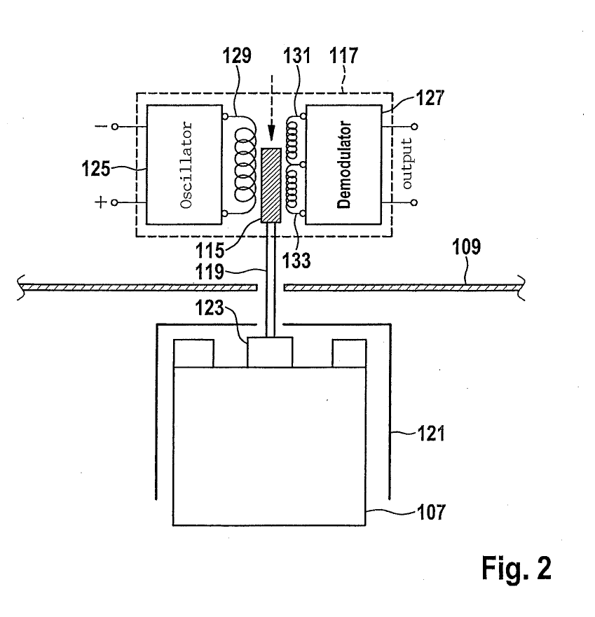

FIG. 2 shows a schematic view of the structure of displacement sensor 117, which is especially suitable for use on an electrical machine 101 to measure the carbon-brush wear. Displacement sensor 117 includes a differential transformer having displaceable measuring pin 119, an oscillator 125 and a demodulator 127. Oscillator 125 converts the DC voltage of the vehicle electrical system, supplied at the input, into an AC voltage and supplies it to a primary coil 129. Demodulator 127 is connected to two secondary coils 131 and 133, which are coupled electromagnetically to primary coil 129. Demodulator 127 is used to filter an output voltage and to compare the voltages induced in the first and second secondary coils. If measuring pin 119 shifts in the interior of displacement sensor 117, the inductive coupling between primary coil 129 and secondary coils 131 and 133 changes depending on the position of measuring pin 119. Demodulator 127 then outputs an output voltage which is linear to the wear of carbon brush 107.

Measuring pin 119 of displacement sensor 117 may be constructed of a carbon-fiber-reinforced material (CFK material) which may be cemented into holder 123 of a carbon brush 107. CFK material is particularly well-suited for this purpose because of its low coefficient of thermal expansion of approximately 0.2×10⁻⁶ mm/K and because of its low weight.

Starting from carbon-brush box 121, measuring pin 119 of displacement sensor 117 is brought out of motor housing 109 via a bore hole in motor housing or field frame 109. At the end of the measuring pin, a metallic cladding is located in the interior of displacement sensor 117.

In another specific embodiment, for sensors where the sensor core or measuring pin 119 is not in permanent contact with carbon brush 107, other materials may also be used, e.g., a metal pin.

In the case of the specific embodiment without permanent contact with carbon brush 107, upon standstill of electrical machine 101, measuring pin 119 may be lowered in automated fashion onto carbon brush 107. This may be accomplished by a switchover of the electronics or an additional auxiliary device. After positioning, displacement sensor 117 is energized for a measurement, so that the output voltage may be tapped on the secondary side. Before the electrical machine turns on, measuring pin 119 is withdrawn by the auxiliary device and the current feed is switched over. By measuring the wear of carbon brush 107 at specific time intervals, it is possible to achieve the advantage, for example, that the volume of data obtained is reduced, and the energy expended for monitoring the wear decreases. For instance, the measurement could be performed on the basis of a date determined by a time-measuring device, so that a measurement is only carried out every 30 days. In another specific embodiment, the measurement may be performed on the basis of a kilometer reading, e.g., in each case after 10,000 vehicle kilometers. In a further specific embodiment, the measurement may be performed based on the number of starts, e.g., always after 5,000 starts.

The dimensions of the sensor may be specially selected so that the necessary measuring range is maintained, but at the same time, the dimensions of the sensor housing are kept as small as possible, in order to keep the mounting space of electrical machine 101 small.

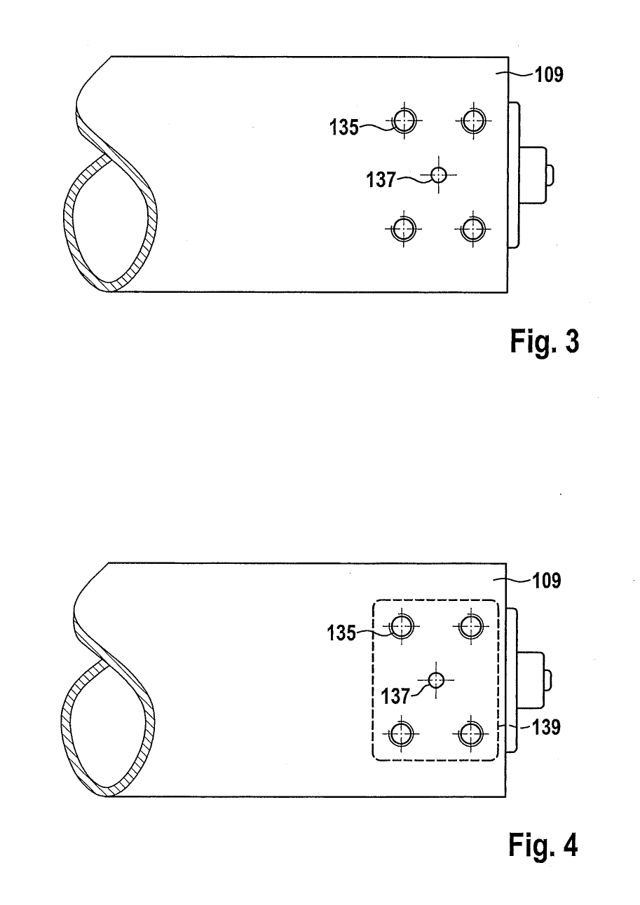

FIG. 3 shows a top view of a specific embodiment of motor housing 109. Motor housing 109, which is produced for use in combination with the displacement sensor described above, has at least one through hole 137 at a specific location for leading measuring pin 119 through over carbon brush 107.

Moreover, in the rear area over commutation system 145, motor housing 109 has tapped holes 135 for securing the sensor or sensor housing.

FIG. 4 shows a top view of a further specific embodiment of a motor housing 109. In this specific embodiment, motor housing 109 has a depression 139 over commutation system 145, into which the housing of the sensor may be inserted. For example, such a depression may be produced by a milling cutting. Depression 139 is used to better position the sensor housing. The remaining reference numerals denote the same features as in the previous figure.

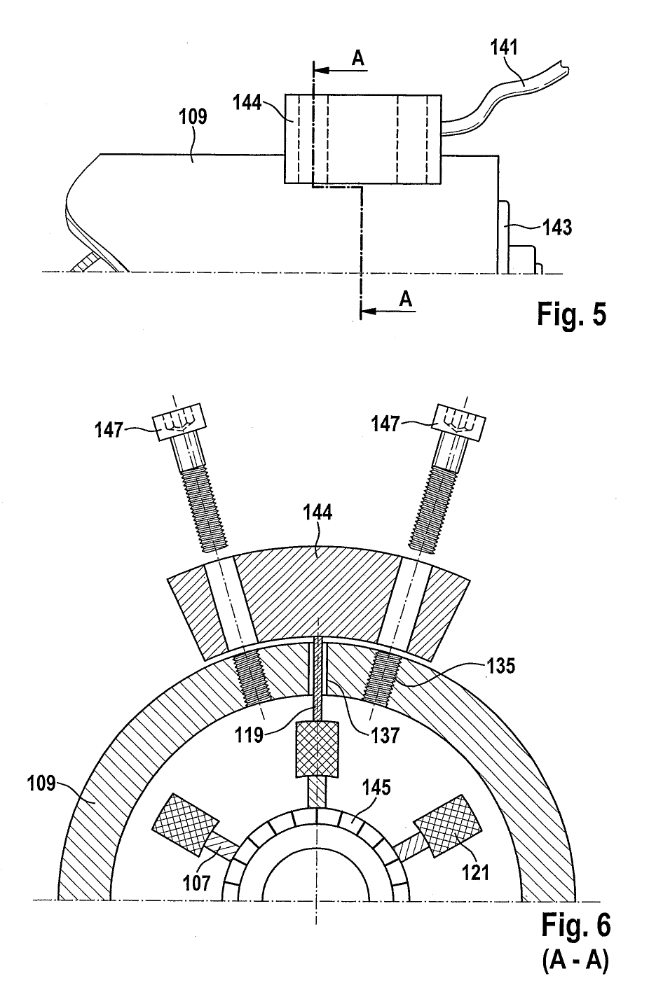

FIG. 5 shows the securing of sensor housing 144 to an electrical machine, e.g., a start/stop starter motor. Sensor housing 144 is disposed on housing 109 of electrical machine 101. The measured values obtained for the wear are transmitted via a signal line 141 to an evaluation unit (not shown). On the right side, housing 109 has a locking cap 143 which may be opened to exchange carbon brushes 107.

FIG. 6 shows a schematic cross-sectional view of electrical machine 101 having sensor housing 144 at the lines denoted by A from FIG. 5. Sensor housing 144 is secured to motor housing 109 by cylinder-head screws 147 in tapped holes 135. In addition, in the rear area outside, motor housing 109 may include a depression or notch 139 over commutation system 145 to better position sensor housing 144.

Through hole 137 is situated directly over one or more carbon brushes 107, which are in brush boxes 121. Carbon brushes 107 produce a conductive contact to commutator 145.

Measuring pin 119 is led through feed-through opening 137 and is in contact with displaceable brush boxes 121. Measuring pin 119 is either permanently in contact with carbon brush 107, or is moved or lowered in automated fashion onto a carbon brush 107 only for the wear measurement.

It is advantageous if the sensor has a mounting face that is circular-arc-shaped in cross section, since in this case, the sensor may be mounted easily on a motor housing 109 which is circular-arc-shaped in cross section. In this instance, the outer surface opposite the mounting face may also have a circular-arc-shaped cross section, so that the cylinder-head screws may be screwed in in the radial direction.

All features shown and described may be combined expediently with each other in any manner, in order to simultaneously attain their advantageous effects.

What is claimed is:

1. An electrical machine configured as a starter motor for a motor vehicle, comprising:
at least one carbon brush producing an electrical sliding contact with a commutator; and
a displacement sensor detecting wear of the carbon brush.

2. The electrical machine as recited in claim 1, wherein the displacement sensor is configured to detect a displacement of the carbon brush.

3. The electrical machine as recited in claim 2, wherein the displacement sensor includes a measuring pin which is in contact with the carbon brush.

4. The electrical machine as recited in claim 3, wherein the measuring pin includes a carbon-fiber-reinforced plastic.

5. The electrical machine as recited in claim 4, wherein the measuring pin includes a metallic cladding.

6. The electrical machine as recited in claim 2, wherein the displacement sensor includes a primary coil and at least one first secondary coil.

7. The electrical machine as recited in claim 6, wherein the displacement sensor includes an oscillator for converting a DC voltage into an AC voltage.

8. The electrical machine as recited in claim 7, wherein the oscillator is connected electrically to the primary coil.

9. The electrical machine as recited in claim 7, wherein the displacement sensor includes a demodulator for filtering an output voltage.

10. The electrical machine as recited in claim 9, wherein the displacement sensor includes a second secondary coil.

11. The electrical machine as recited in claim 10, wherein the demodulator is connected electrically to the first and second secondary coils.

12. The electrical machine as recited in claim 11, wherein the demodulator includes a comparator for comparing voltages induced in the first and second secondary coils.

13. The electrical machine as recited in claim 5, further comprising:
a motor housing having a feed-through opening through which the measuring pin is inserted.

14. The electrical machine as recited in claim 13, wherein the motor housing has at least one tapped hole for securing the displacement sensor.

15. The electrical machine as recited in claim 13, wherein the motor housing has a depression for accommodating the displacement sensor.

16. The electrical machine as recited in claim 13, wherein the feed-through opening is located directly over the at least one carbon brush.
